(19) United States
(12) Patent Application Publication
(10) Pub. No.: US 2011/0181710 A1
(43) Pub. Date: Jul. 28, 2011

(54) ARRANGEMENT AND METHOD FOR IMAGE ACQUISITION ON A PROBER

(75) Inventors: Michael Teich, Moritzburg OT Friedewald (DE); Axel Becker, Dresden (DE)

(73) Assignee: SUSS MicroTech Test Systems GmbH, Sacka (DE)

(21) Appl. No.: 12/847,308

(22) Filed: Jul. 30, 2010

Related U.S. Application Data
(63) Continuation of application No. 11/964,747, filed on Dec. 27, 2007, now abandoned.

(30) Foreign Application Priority Data
Dec. 27, 2006 (DE) 10 2006 062 297.9

(51) Int. Cl. H04N 7/18

(52) U.S. Cl. 348/79; 348/E07.085

(57) ABSTRACT

In a system and a method for capturing images in a prober, the surface of a test object is illuminated in succession with light of a first, second and third color; an image capturing device records a gray scale image of the surface; and a composite image is produced from the three gray scale images by an image evaluating device. The object is to qualitatively improve the image capturing, in order to raise the positioning accuracy by an improved display, as a result of which, finely structured test objects can be used. This object is achieved in that the lighting device is designed as a unit, controlled by the image evaluating unit, produces at least three colors and includes at least one light emitting diode (LED) as the lighting source.

### CROSS REFERENCE TO RELATED APPLICATIONS

This application claims priority of German Application No. 10 2006 062 297.9 filed on Dec. 27, 2006, which application is hereby incorporated by reference, in its entirety.

### BACKGROUND ART

The invention relates to a system for capturing images in a prober, which is provided with a movement device and a clamping fixture for a test object; and said clamping fixture is mounted on said movement device. Furthermore, the prober exhibits probe needles, which can make contact with the test object; holding devices for the probe needles; and a clamping plate, which is arranged above the clamping fixture and on which the holding devices can be mounted and which exhibits a viewing aperture, which visibly exposes the surface of the test object. The system for capturing images is provided with an image capturing device, which is mounted above the viewing aperture and which is connected to an image evaluating unit and which is provided with a lighting device, which produces a light beam, directed on the surface of the test object.

The invention also relates to a method for capturing images in a prober. According to this method, the surface of a test object is illuminated in succession with light of a first, second and third color; and an image capturing device records a gray scale image of the surface; and a composite image is produced from the three gray scale images by means of an image evaluating device.

It is known from the U.S. Pat. No. 4,875,991 to use black and white cameras to produce a color image. Said cameras record images that are produced in succession with lighting that is filtered or composed of a plurality of different colors. Hence, for example, the red lighting gives a gray scale image; and a blue lighting gives a gray scale image; and a green lighting gives a gray scale image; and then these images are assembled to form one color image. This solution has the advantage that in each case the total resolution of the camera can be utilized, because only one gray scale is to be determined of each pixel. If pixels, which were recorded in all three colors simultaneously, were to be used, only one-third of the resolution would be available. This prior art describes that the object is illuminated in succession with light of red, green and blue color. The lighting means that were available at the time of this patent application consisted of filament lamps.

The illumination with the light of the respective color takes place over a period of time that is independent of the period of time in which the camera captures the image. Usually cameras capture the image only during the time that the shutter is open—the so-called shutter time. However, the lighting device illuminates the object irrespectively of this shutter time.

Even though the said patent document does not describe the use of such a three-part production method of color images for probers, such a practice does exist in probers.

In general, probes are used to test components, in particular semiconductor components, for their operational function and the impact that physical parameters have on them. To this end, the prober generally consists of a movement device, for example, an X-Y cross-table, which can also perform slight rotary motions in order to correct the position. This movement device has a clamping fixture—a so-called chuck. Hence, the test object can be mounted on this clamping fixture. Above the clamping fixture is a clamping plate, which is provided with a feed-through and viewing aperture. At this stage holding devices for the probe needles can be mounted on this clamping plate, for example, by means of vacuum holders, so that the probe needles can extend through the feed-through and viewing aperture and make an electric contact at the corresponding points on the object to be tested, thus measuring the object to be tested for its electrical properties.

There also exist solutions with so-called probe cards, where the probe needles are mounted, as the probe card needles, securely on the probe card; and then the probe card is placed securely in the clamping plate.

Basically the objects to be tested have to be positioned in relation to the tips of the probe needles. To this end, a vertical motion of the movement device usually brings about a separation between the object to be tested and the probe needles. Then the movement device moves the clamping fixture and, thus, the object to be tested in such a manner that another test object or another part of the test object comes to rest below the tips of the probe needles. Thereafter, an additional vertical motion places again the object to be tested into contact with the tips of the probe needles. As a rule, this positioning operation is controlled by an image capturing device, for example, a video camera, which is mounted above the viewing aperture. The image capturing device photographs the surface of the object to be tested, which in turn is passed to an image evaluating device. Then with the image evaluating device it is possible to control with suitable analysis programs the movement device so accurately that the tips of the probe needles come to rest directly over the corresponding contacts on the test object; and the measuring process can begin.

At this stage it is known to use a tricolor image capturing process in such probers. In this case light emitting diodes (LED's) are used as the lighting devices. These LED's also emit light during the entire period that is provided for capturing a gray image of a certain color. Therefore, the LED has the task of illuminating for a relatively long period of time. Correspondingly the diode current must be set in such a manner that it matches a maximum continuous diode current. On the one hand, the relatively long term usage of an LED does not have a significantly negative impact on the service life of the LED. On the other hand, only average luminance can be achieved with a continuous diode current.

### BRIEF SUMMARY OF THE INVENTION

Therefore, for the above reasons, the object of the invention is to qualitatively improve the image capturing in a prober, in order to raise the positioning accuracy by means of an improved display. As a result, it will be possible to use finely structured test objects.

This object of the invention is achieved with a system, wherein the lighting device is designed as a unit, which can be controlled by the image evaluating unit and which produces at least three colors and which exhibits at least one light emitting diode (LED) as the lighting means.

Controlling the LED by means of the image evaluating unit makes it possible to control the LED in such a manner that it illuminates for such a period of time that is adequate to produce a proper image of the test object. For example, it will be possible to switch on the LED for a very short period to time, thus avoiding motion blur.

One embodiment of the invention provides that the LED is designed as a tricolor LED. This tricolor LED is constructed in such a manner that when suitably driven, it can produce a light in the three colors.

Another embodiment of the invention provides that the lighting device contains three LED's, each of which produces light of a different color. The use of three separate LED's makes it possible, inter alia, to arrange them spatially in such a manner that they are separated from each other, thus exploiting the spatially induced lighting effects.

It is desirable to render the generated color image in fast colors, for which reason the three colors red, green and blue are chosen, in that the three LED's or the tricolor LED's produce these three colors. However, it is also possible, in principle, to use intentionally other colors, for example, in order to show the fine structures with a higher definition. In this case it is just as possible to use ultraviolet light as it is to use infrared light.

Another advantageous embodiment of the invention provides that the image capturing device is designed as a video camera, which exhibits a switching output, which outputs a shutter signal at a shutter time. The switching output is connected to the image evaluating unit in such a manner that the image evaluating unit controls the LED or the LED's as a function of the occurrence of the shutter signal. Thus, it becomes possible for the camera to initiate the targeted control of the LED. In this way it is possible to realize, in particular, shorter operating times of the LED, for example, with higher diode currents, and, thus, achieve, a kind of flash. As a result, motion blurs can be eliminated.

Another embodiment of the invention provides that the video camera is designed as a black and white camera that captures gray scales. Thus, it is possible to include gray scales in the imaging matrix of the video camera at each pixel of the imaging matrix. As a result, the highest possible geometric resolution for a given camera chip is achieved. Then the high geometric resolution can be totally utilized to display the color, so that a high resolution color image can be produced by means of a method that uses such a black and white camera.

In optical lens systems the optical dispersion, i.e. the refraction of the light as a function of the wavelengths of the light, produces a chromatic aberration, i.e. an imaging error of the optical lens system that can manifest itself in, inter alia, blurring.

The inventive use of LED's supplies a relatively monochromatic light or, even better, a light in a very narrow spectrum. As a result, the chromatic aberration errors are reduced in accordance with the Abbe definition. Hence, the images are sharper, because the focus can be adjusted in an optimal manner to the wavelength of the light. Furthermore, there is the advantage that a partial color image—for example, the blue color image—can be recorded, in order to target a high resolution. The blue image is the image that is illuminated with the shortest wavelength. Hence, images with the highest definition are possible. That is, the gray image, which is produced with the blue lighting, can be better evaluated, for example, for a geometric analysis. Another advantage lies in the ability to use images with the best contrast. To this end, one selects the image of the partial color images with the best contrast in order to use it then for further evaluation.

Even if the chromatic aberration error can be largely reduced by means of the invention, it is still possible to detect some blurring as a consequence of the chromatic aberration errors. Usually the objective lenses for rendering a color image that is as sharp as possible are set to three spectral colors (apochromates). That is, in these three spectral ranges these objective lenses usually deliver sharp images. However, these three spectral ranges do not have to match the spectral lines of the colors, produced by the LED's—in particular, not the spectral lines of red, green and blue. In order to use commercially available objective lenses (for the purpose of increasing the cost efficiency), whose chromatic adjustment lies perhaps in other color ranges, another embodiment provides that the image capturing device has an objective lens, which can be adjusted by means of a motor and which can be controlled by the image evaluating unit so as to correspond to the control of the lighting device. In an advantageous further development the objective lens can be driven by a piezo drive.

Such an adjustability of the objective lens makes it possible to set the focus to correspond to the color of the respective LED that is emitting light at the moment. Thus, it is guaranteed that each chromatic aberration error can be eliminated. In addition, it is possible to use very economical objective lenses that perhaps do not require any chromatic adjustment at all.

The problem, on which the invention is based, is solved by a method, wherein the light of each color is produced by an LED; and the operating times can be controlled to correspond to the image capturing device. Thus, for example, it is possible to switch on the LED exactly in the shutter frame of the image capturing device. Similarly other targeted operating times—that is, operating times that deviate from the shutter frame—are also possible.

An advantageous embodiment of the invention provides that the light is produced by means of a tricolor LED. Such a tricolor LED exhibits a low spatial coverage and must, therefore, be brought relatively close to the test object or is very easy to integrate into a lighting device of the microscope, where the illuminating light is coupled into the beam path of the objective lens.

As an alternative, it may be desirable that the light is produced by means of each LED. As a result, a spatial distribution of the generated light is possible.

In principle, all possible colors from ultraviolet to infrared for illuminating the test object are possible. It is advisable to select, depending on the application, a suitable color configuration. It has proven to be advantageous to select the colors red, green and blue, in order to represent fast colors.

Another practical embodiment of the invention provides that the gray scale images are produced with a video camera, which is ready to shoot only during shutter time periods (shutter frames), which follow sequentially and are limited in time. In the case of such a camera, a shutter start signal is produced at the beginning of each shutter frame. This shutter start signal is usually emitted by the video camera by way of the switching outputs. The LED or the LED's is/are now controlled as a function of the shutter start signal in such a manner that they are switched on for a period of time within a shutter frame, thus producing one color per each sequential shutter frame.

As a result of this control process, sequences of images are produced that represent in succession an image in a different color. After three images, the representation with the first color repeats. Of course, there is also the option of selecting a different timing that, for example, excludes the one or the other shutter frame for capturing an image, if this appears to be practical.

Another advantageous embodiment of the method provides that the time period for switching on the LED(s) is equivalent at most to the length of the shutter frame. Therefore, it is possible to switch on the LED's during the entire respective shutter frame. During other periods of time, when, for example, data are transferred from the video camera to the image evaluating unit, the LED's are switched off.

However, in a very advantageous embodiment this inventive method makes it also possible to select a period of time for switching on the LED(s) that is shorter than the shutter frame. The shorter the on time, the lower the risk of a motion blur. In particular, it is possible to select the ratio of the on time of an LED to a shutter frame so that it ranges from 1:1 to 1:100. At a high ratio—for example, 1:100—the short illumination of the LED acts like a light flash. In this case stroboscopic effects can be used. That is, the image is captured only for a short flash period, thus with high definition. If the object moves, a new flash occurs at a later point in time, thus producing a sharp image, so that no motion blurs occur.

The needles are usually moved in probers. In the image display the needles are shown as black and white objects or as black objects. If images can be captured at a fast frame rate (that is, the image refresh in each frame, that is, in the red, green and blue frame), then the display of the moved black needle is always sharp. The image refresh of the composite color image—that is, the color image composed of red, green and blue—does not exhibit any drawbacks, because the color of the underlying substrate does not change over time. Hence, the image of the moved object that is of interest—that is, the needle—is always sharp.

Another embodiment of the invention provides that, when the LED(s) is/are switched on, they are operated with a diode current that is higher than the allowable continuous diode current. This feature is achieved in that the LED is switched on only for a short period of time during the shutter frame. If during continuous operation the diode current is limited due to the thermal effects, then, as a consequence of the short on time, a significantly higher diode current can be selected, since this action will not lead to any thermal effects or, in the event that it does, said thermal effects can be ignored. The higher diode currents significantly improve the light intensity of the LED, which in turn also aids in generating a light flash.

In addition to the fact that the luminance is increased, it has also been demonstrated that the short-term actuation of the LED also results in a prolonged service life. This feature is achieved in that the LED is switched on only during the shutter time or during a portion of the shutter time and is switched off during the camera transfer time. Consequently the on time is significantly shorter than the off time, a feature that results in the said extension of the service life.

In addition, it is possible to exploit another advantage that commercially available video cameras offer. The cameras themselves can transmit either a lower image resolution or smaller image sections. The lower image resolution or the smaller image sections reduce the amount of time for transmitting the image from the camera to the image evaluating unit, so that the camera is more quickly available again for shooting. This means that the LED's are more quickly available again for illumination purposes. According to the known state of the art, the light source would have to be switched on for such fast image sequences. In the case of a single lighting source with filter systems that are switched on in succession, the dynamic limits of a higher frame rate would soon be reached with certainty.

Another embodiment of the invention provides that a focusing signal corresponding to each color is produced and sent to the image capturing device. Prior to each on time, the image capturing device is focused, according to the color, by means of this focusing signal. This feature makes it possible to adjust the objective lens, for example, by means of an attached computer in such a manner that the objective lens is in optimal focus for the switched on light flash of an LED. Since the color sharpness may be corrected by means of a piezo drive, there is, in principle, the possibility of using more economical objective lenses. Thus, it is possible to dispense with the use of relatively expensive apochromates—that is, the objective lenses are optimized in three spectral ranges—and, instead, to use achromates—that is, the objective lenses are optimized in only two spectral ranges.

Another embodiment of the method provides that, when the test object is moved in relation to the image capturing device, the composite image is shown as a gray scale image. This feature largely eliminates by optical means a blurring of the colors (as could be the case during a color production of the composite image from three partial images, which follow chronologically in succession, in the individual illumination colors—especially during relatively long data processing periods.

As an alternative or in addition, the color blurring can be avoided in that, when the test object is moved in relation to the image capturing device, the test object is illuminated with white light or with a fast sequence of light flashes of the three colors within a shutter frame. This procedure always produces images that correspond to the same color and, thus, renders the temporal differences between the sequential partial images ineffective.

As a result of the above reasons, the advantageous inventive method for capturing tricolor images can be carried out especially when the test object is stationary; and during times of relative motion, at least one colored display of the composite image is avoided.

### BRIEF DESCRIPTION OF THE DRAWING FIGURES

The invention is explained in detail below with reference to one embodiment.

FIG. 1 depicts an inventive prober in an embodiment with probe needles.

FIG. 2 depicts an inventive prober in an embodiment with a probe card.

FIG. 3 is a sectional drawing of an inventive image capturing device; and

FIG. 4 depicts the control of the inventive system, according to the inventive method.

### DETAILED DESCRIPTION

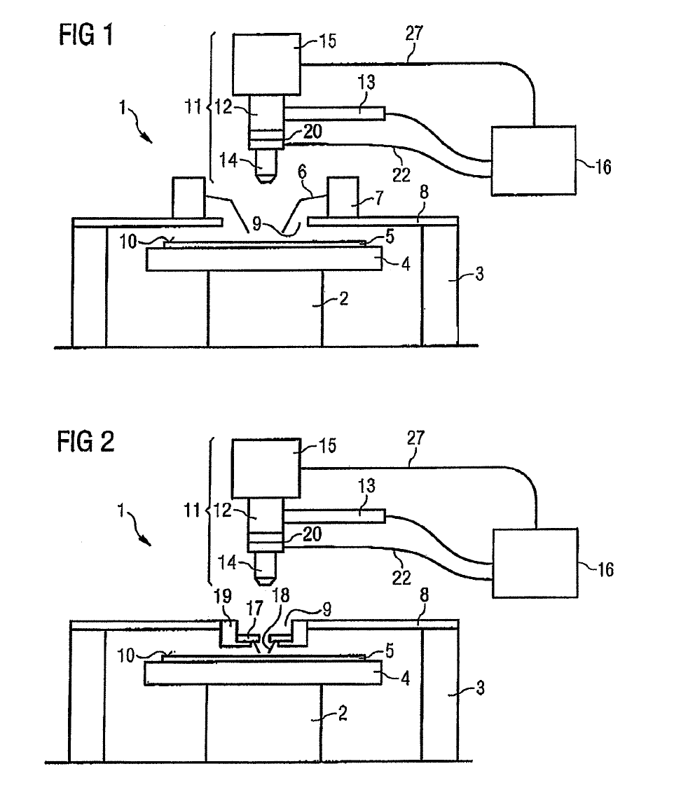

As shown in FIG. 1, a prober 1 comprises an X-Y cross table 2 as a movement device. The X-Y cross table 2 is disposed in a housing 3. A clamping fixture 4 is mounted on the X-Y cross table. In this case the clamping fixture 4 can be rotated by an angle O. The clamping fixture 4 serves to receive a test object 5. The test object 5 may be, for example, a semiconductor wafer, on which there are a plurality of semiconductor chips, which in turn exhibit individual contact pads. In order to test the test object 5, probe needles 6 make contact with said test object. An external test circuit (not shown in detail) makes contact, for example, with the contact pads of a semiconductor wafer, as the test object. Therefore, said contact pads are driven with electric signals; and in this way their reaction is determined.

One end of the probe needles 6 is fastened in probe holders 7. Hence, on the one hand, the probe holders serve to hold the probe needles and, on the other hand, to fine position the probe needle in relation to the test object. In order to fasten the probe holders 7, there is a clamping plate, a so-called probe holder plate 8. The probe holders 7 can be vacuum mounted on this probe holder plate 8 and are, thus, fixed in place.

The probe holder plate 8 is provided with an aperture 9. On the one hand, this aperture 9 exposes at the top the surface 10 of the test object 5 for observation. On the other hand, it is possible for the probe needles 6 to extend through this aperture 9 from the top side of the probe holder plate 8 as far as to the test object 5.

An image capturing device 11 is mounted above the viewing aperture 9 in the probe holder plate 8. This image capturing device 11 comprises a microscope 12 with a lighting device 13 and an objective lens 14 and a video camera 15. The video camera 15 is connected to an image evaluating unit 16. The image evaluating unit 16 in turn comprises a computer with suitable analysis software.

FIG. 2 shows a design that is analogous to the design described in FIG. 1. The major distinction between the two embodiments lies in the use of a probe card 17 in FIG. 2, instead of individual probe needles 6 with separate probe holders 7. This probe card 17 exhibits its own probe card needles 18 and is held in the aperture 9 by means of a probe card adapter 19.

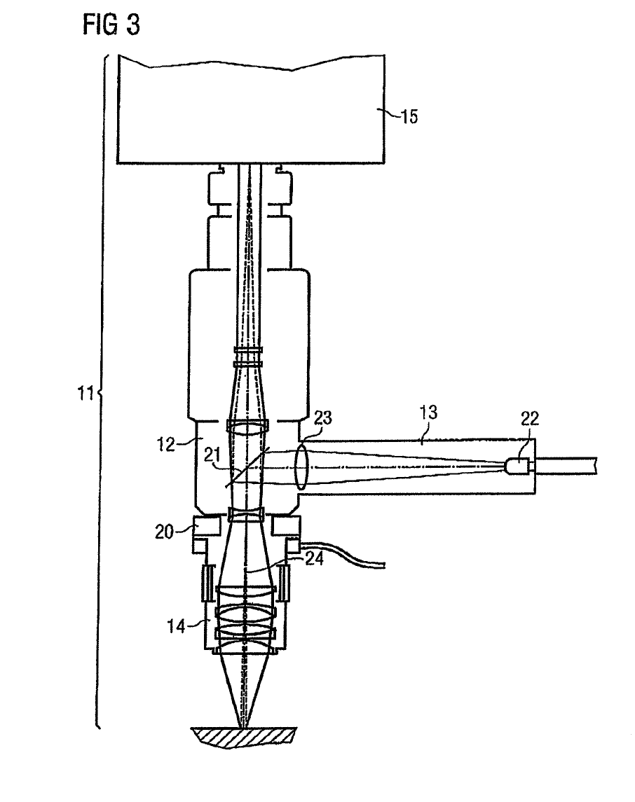

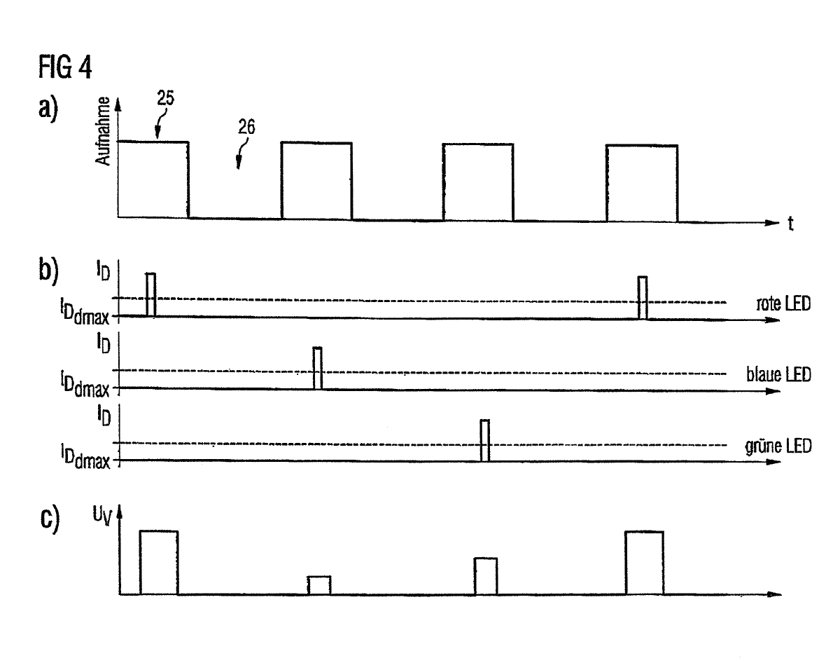

The image capturing unit, as depicted in FIGS. 1 and 2, is enlarged once again in FIG. 3 and shown as a sectional drawing.

For focusing purposes, the objective lens 14 is provided with a microscope objective lens focusing unit 20. This microscope objective lens focusing unit comprises a piezo drive (not illustrated in detail), which is made of a quartz that changes geometrically on applying a voltage; and, as a consequence of this geometric change, the objective lens 14 is adjusted in its focusing distance. At this stage the microscope objective lens focusing unit 20 is connected to the image evaluating unit 16, so that owing to the software, which is installed in the image evaluating unit 16, the microscope objective lens focusing unit 20 can adjust the focus of the objective lens very quickly to correspond to the images to be captured (to be explained below).

The lighting device 13 couples the light for illuminating the surface 10 of the test object 5 into the beam path of the objective lens by means of the semi-reflective mirror 21. In so doing, the light for illumination purposes is produced by means of an LED 22. This LED 22 is designed as a tricolor LED, that is, it exhibits connectors, by means of which on applying a voltage to the LED, different colored light—in this case preferably red, green, and blue—can be produced in accordance with the selection. This light travels now over a condenser lens 23 into the beam path 24 of the objective lens. Thus, this illumination becomes effective on the surface 10 of the test object 5.

Furthermore, the beam path 24 travels to the video camera 15. At the camera the image is converted into electric signals by means of a suitable image capturing matrix, which is not illustrated in detail. The electric signals in turn are fed back to the image capturing device 11. The image is captured in this camera during image capturing periods—so-called shutter frames 25—which are shown in FIG. 4a. In the interims 26 between the shutter frames 25 the image data—the images—that had been recorded in the shutter frames 25 are then transmitted. The beginning and the end of the shutter frame 25 is also transmitted by means of the connection 27 between the video camera 15 and the image evaluating unit 16. Thus, it is possible for the software in the image evaluating unit to drive the LED 22 in such a manner that the LED is switched on for a short period of time during the shutter time periods. Therefore, the software does not have to apply continuous voltage to the LED, thus not emitting light continuously. As a consequence, it is possible that only short-term thermal stresses on the semiconductor transition regions to the LED will occur. For this reason the LED's are driven with a higher diode current. On the one hand, the result is a higher light efficiency during the on time; and, on the other hand, the service life of the LED 22 is extended. As FIG. 4b shows, the LED 22 is switched on in succession in the individual colors red, blue and green. That is, during the first shutter frame 25, the LED 22 is switched on in order to produce a red color. During the second shutter frame 25 the LED 22 is switched on in order to produce a blue color; and finally during the third shutter frame the LED is switched on in order to produce a green color. Then the procedure is repeated again by switching on the LED in order to produce a red color.

In this way the images in the individual shutter frames are transmitted in a different color of the three colors. Then, inside the image evaluating unit 16 the three color images are put together to form one color image. In so doing, the images in the individual colors can be transmitted as gray scale images, to which when producing the images, the original colors are allocated; or when intentionally misrepresenting the color external colors may also be allocated. Since the objective lens 14 exhibits an aberration error, as explained in connection with the description of the state of the art in the introductory part, it is desirable to use the microscope objective lens focusing unit 20 to focus the objective lens 14 in accordance with the color, which has been produced by the lighting device 13. As FIG. 4c shows, the microscope objective lens focusing device 20 is sent a varying adjustment voltage. As a result, the adjustment of the objective lens 14 is optimal with respect to the respective color of the LED 23 that is used.

During a movement, especially during fast motions of the object to be imaged, the color in the display of the composite image blurs due to the illumination which occurs in chronological sequence. This color blurring is also dependent on the respective processing speed during the production of the composite image. In order to approach such a blurring of the color, it is desirable to suspend the color image production of the composite image during such a movement process and, instead, to realize a pure gray scale rendering of the composite image.

1. System for capturing images in a prober comprising a movement device; a clamping fixture mounted on said movement device for receiving a test object; probe needles to make contact with the test object; holding devices for the probe needles; a clamping plate arranged above the clamping fixture and on which the holding devices are mounted and which has a viewing aperture which visibly exposes a surface of the test object; and an image capturing device mounted over the viewing aperture connected to an image evaluating unit and provided with a lighting device, the lighting device produces a light beam, directed on the surface of the test object, wherein the lighting device comprises a unit controlled by the image evaluating unit and produces at least three colors and includes at least one light emitting diode (LED) as a lighting source.

2. System as claimed in claim 1, wherein the at least one LED comprises a tricolor LED which produces in a controlled manner a light in three colors.

3. System as claimed in claim 1, wherein the lighting device contains three LED's, each of which produces light of a different color.

4. System as claimed in claim 1, wherein the at least one LED produces light in colors red, green and blue.

5. System as claimed in claim 1, wherein the image capturing device comprises a video camera having a switching output, outputs a shutter signal at a shutter time and is connected to the image evaluating unit so as to control on times of the at least one LED.

6. System as claimed in claim 5, wherein the video camera comprises a black and white camera that records gray scales.

7. System as claimed in claim 1, wherein the image capturing device includes an objective lens adjusted by a motor and controlled by the image evaluating unit so as to correspond to the control of the lighting device.

8. System as claimed in claim 7, wherein the objective lens is provided with a piezo drive.

9. Method for capturing images in a prober, wherein a surface of a test object is illuminated in succession with light of a first, second and third color; and an image capturing device records the gray scale images of the surface; and a composite image is produced from the three gray scale images by an image evaluating device, wherein the light of each color is produced by an LED; and on times are controlled so as to correspond to the image capturing device.

10. Method as claimed in claim 9, wherein the light is produced by a tricolor LED.

11. Method as claimed in claim 9, wherein the light is produced by at least one LED.

12. Method as claimed in claim 9, wherein red, green and blue are selected as the first, second and third colors.

13. Method as claimed in claim 11, wherein the gray scale images are produced with a video camera, which exhibits a readiness to shoot only during shutter frames, which follow sequentially and are limited in time; and a shutter start signal is produced at the beginning of each shutter frame; and the at least one LED is/are controlled as a function of the shutter start signal in such a manner that the at least one LED is/are switched on for a period of time within a shutter frame, thus producing a different color for each successive shutter frame.

14. Method as claimed in claim 13, wherein the time period for switching on the at least one LED is equivalent at most to a length of the shutter frame.

15. Method, as claimed in claim 14, wherein the time period for switching on the at least one LED is shorter than the shutter frame.

16. Method, as claimed in claim 14, wherein the ratio of the on time of an LED to a shutter frame ranges from 1:1 to 1:100.

17. Method, as claimed in claim 14, wherein, when the at least one LED is/are switched on, the at least one LED is/are operated with a diode current that is higher than an allowable continuous diode current.

18. Method, as claimed in claim 9, wherein a focusing signal corresponding to each color is produced and sent to the image capturing device; and prior to each on time, the image capturing device is focused, according to the color.

19. Method, as claimed in claim 9, wherein, when the test object is moved in relation to the image capturing device, the composite image is shown as a gray scale image.

20. Method, as claimed in claim 9, wherein the test object is illuminated with white light or with a fast sequence of light flashes of the first, second and third colors within a shutter frame.
